(19) United States
(12) Patent Application Publication
(10) Pub. No.: US 2016/0330823 A1
(43) Pub. Date: Nov. 10, 2016

(54) WIRELESS DECORATIVE LIGHTING FOR ARTIFICIAL TREES

(71) Applicant: Willis Electric Co., Ltd., Taipei (TW)

(72) Inventors: Alec HWA, Taipei (TW); Johnny CHEN, Taipei (TW); Jiang Hai NIE, Taipei (TW)

(73) Assignee: Willis Electric Co., Ltd., Taipei (TW)

(21) Appl. No.: 15/150,252

(22) Filed: May 9, 2016

Related U.S. Application Data
(60) Provisional application No. 62/159,000, filed on May 8, 2015.

(51) Int. Cl. H05B 37/02; H05B 33/08; H02J 50/20; F21V 23/02

(52) U.S. Cl. CPC H05B 37/0272; F21V 23/02; H05B 33/0809; H02J 50/20; F21W 2121/04

(57) ABSTRACT

A wirelessly-powered lighted tree system that includes: an artificial tree; a wireless power transmission system, including: a power conditioning portion configured to receive an AC power from an external source, and convert the AC power to a DC power, a microwave-frequency signal generation portion configured to receive the DC power from the power conditioning circuit and generate a microwave-frequency signal, a processor, an antenna configured to receive the generated microwave-frequency signal and to transmit a wireless microwave-frequency signal based on the received microwave-frequency signal from the microwave-frequency generation portion; and a wirelessly-powered lighting system configured to receive the transmitted wireless microwave-frequency signal, the lighting system including an antenna receiving the transmitted wireless microwave-frequency signal, a power conversion portion for converting the wireless microwave-frequency signal into a DC power signal, and a plurality of lighting elements coupled to the artificial tree and receiving power based on the DC power signal.

### CROSS-REFERENCE TO RELATED APPLICATIONS

This application claims the benefit of Provisional Application No. 62/159,000, filed May 8, 2015, entitled WIRELESS DECORATIVE LIGHTING FOR ARTIFICIAL TREES, which is incorporated herein in its entirety by reference.

### FIELD OF THE INVENTION

The present invention is generally directed to lighted artificial tree lighting systems, and more specifically to systems, apparatuses and methods for wirelessly powering lights of lighted artificial trees.

### BACKGROUND OF THE INVENTION

Artificial lighted trees often include decorative light strings distributed about the branches of the trees. Such decorative light strings may be of the traditional type having power plugs that may be connected to one another, and to an external power supply. Such well known configurations require that multiple power plugs of multiple light strings be plugged in, resulting in a web of wires wound about the branches of the tree.

Not only are such traditional systems tedious for a user to assemble, but such systems result in a web of wiring on the tree that is unsightly and inconvenient.

### SUMMARY

An embodiment herein comprises a wirelessly-powered lighted tree system that includes: an artificial tree, including a trunk and a plurality of branches; a wireless power system, including: a power conditioning portion configured to receive an alternating-current (AC) power from an external source, and convert the AC power to a direct-current (DC) power, a microwave-frequency signal generation portion configured to receive the DC power from the power conditioning circuit and generate a microwave-frequency signal, a processor in electrical communication with the power-conditioning portion, an antenna in electrical communication with the microwave-frequency signal generation portion and configured to receive the generated microwave-frequency signal and to transmit a wireless microwave-frequency signal based on the received microwave-frequency signal from the microwave-frequency generation portion; and a wirelessly-powered lighting system configured to receive the transmitted wireless microwave-frequency signal, the lighting system including an antenna receiving the transmitted wireless microwave-frequency signal, a power conversion portion for converting the wireless microwave-frequency signal into a DC power signal, and a plurality of lighting elements coupled to the artificial tree and receiving power based on the DC power signal.

In an embodiment, the wireless power transmission system comprises a wireless power and data transmission system.

Another embodiment includes the wirelessly-powered lighted tree system described above, wherein the transmitted wireless microwave-frequency signal is a wireless signal having a frequency in the range of 7 GHz to 10 GHz.

Another embodiment includes the wirelessly-powered lighted tree system described above, wherein the wireless power and data transmission system further comprises a modulation portion, and wherein the transmitted wireless microwave-frequency is a modulated wireless signal that includes a data signal portion.

Another embodiment includes a method of wirelessly powering an artificial tree having a plurality of lighting elements distributed about branches of the tree, comprising: causing a wireless power and data transmission system to transmit a wireless microwave-frequency signal; receiving a wireless signal based on the wireless microwave frequency signal at a wirelessly-powered lighting system, the lighting system attached to a branch of an artificial tree; and converting the received wireless signal to a DC power signal and powering a lighting element of the lighting system using the DC power signal.

### BRIEF DESCRIPTION OF THE FIGURES

The invention can be understood in consideration of the following detailed description of various embodiments of the invention in connection with the accompanying drawings, in which:

FIG. 1 depicts an embodiment of a lighted artificial tree having a system for wirelessly powering lighting elements of the tree;

FIG. 2 depicts an embodiment of a block diagram of the wireless light system of FIG. 1;

FIG. 3 depicts an alternate embodiment of the lighted artificial tree system of FIG. 1;

FIG. 4 depicts another alternate embodiment of the lighted artificial tree system of FIG. 1;

FIG. 5 depicts an embodiment of a lighted artificial tree having a system for wirelessly power and controlling lighting elements of a tree in the microwave frequency;

FIG. 6 depicts an embodiment of a block diagram of a wireless power and data transmission system of the wirelessly-powered lighted tree of FIG. 5;

FIG. 7 depicts an embodiment of a block diagram of a wirelessly-powered light system of FIG. 5; and

FIGS. 8a-8d depict embodiments of light systems of FIG. 7.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

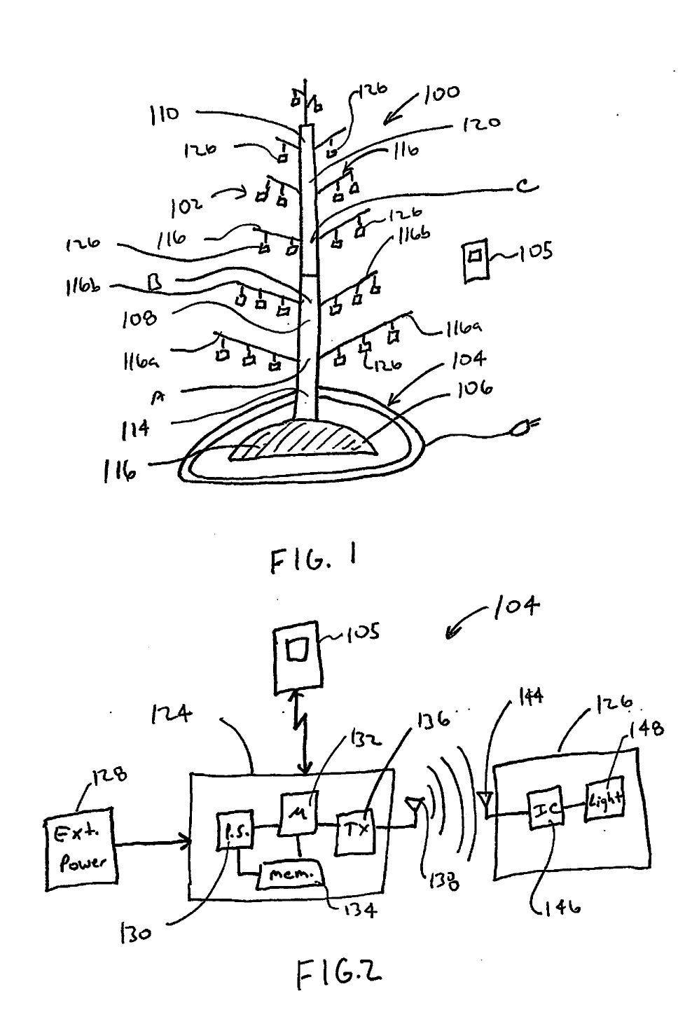

Referring to FIG. 1, an embodiment of lighted tree system 100, according to an embodiment, is depicted. Lighted tree system 100 includes lighted tree 102 and wireless light-power system 104, in an embodiment. Lighted tree system 100 may also include remote control device 105, though remote control device 105 is optional in some embodiments.

In an embodiment, lighted tree 102 includes base 106, first tree section 108 and second tree section 110. In an alternative embodiment, artificial tree 102 may only include a single tree section, or may include more than the two tree sections depicted.

Base 106 is configured to support first tree section 108, and may be configured to receive a portion of a trunk of tree section 108 in a vertical position. Base 106 may comprise any of a variety of structural configurations, including the one depicted. In an embodiment, base 106 comprises a housing 112 that defines an inner cavity for housing various components of wireless light-power system 104, power-supply components, wiring, wireless or wired communication components, and so on. Base 106 may comprise multiple “legs” extending outwardly from a center portion of base 106 to support artificial tree 102.

First tree section 108 includes trunk portion 114 and a plurality of branches 116. Branches 116 are coupled to trunk portion 114 and extend outwardly and away from trunk portion 114. In an embodiment, trunk portion 114 may comprise a metal material, and may generally be hollow, defining an interior cavity. In an embodiment, branches 116 are arranged at discrete “heights” along trunk portion 114, such as heights A and B. In an embodiment, branches 116a are all coupled to trunk portion 114 approximately at a common height A of trunk portion 114; branches 116b are all coupled to trunk portion 114 approximately at a common height B of trunk portion 114. Such an embodiment may contribute to a more uniform reception of electromagnetic energy received by the lights of artificial tree 102, as described further below. Second tree section 110 is substantially the same as tree section 108, and includes trunk portion 120 and branches 116. In an embodiment, groups of branches 116 may be coupled to trunk portion 120 at common trunk portion locations or heights, such as at height C.

First tree section 108 is configured to mechanically couple to second tree section 110 at their respective trunk portions, along a common vertical axis. In an embodiment, and as described in more detail below with respect to FIG. 4, in addition to a mechanical coupling of tree section 106 and 108, the tree sections may also electrically couple via power transmission connectors, such that power is transferred from tree section 106 to tree section 108.

Referring also to FIG. 2, wireless light-power system 104 includes electromagnetic power-generation unit 124 and one or more lighting units 126. Electromagnetic power-generation unit 124 may be configured to receive power from external power supply 128, which in an embodiment, may comprise an alternating-current (AC) power supply as may be commonly found in many homes and businesses. In an embodiment, power-generation unit 124 may be configured to receive a 120 VAC power.

Electromagnetic power-supply unit 124 may include power-supply and conditioning circuitry 130, controller or microcontroller 132, memory 134, transceiver circuitry 136 and power antenna 138, in an embodiment. In an embodiment, power-supply unit 124 may include a second antenna (not depicted) devoted to data transmission.

Lighting unit 126 includes antenna 144, integrated circuit 146 and lighting unit 148, in an embodiment. Integrated circuit 146 may include various power-supply and conditioning circuitry, sensors, and other components. Although depicted and described as an “integrated circuit” (IC) it will be understood that integrated circuit 146 may actually comprise other electrical components not necessarily integrated onto a single chip, but for the purposes of simplicity, “integrated circuit” will be used to refer generally to the electrical circuitry providing most functions of lighting unit 126, with the exception of lighting unit 148.

Lighting unit 148 is in electrical communication with IC 146, and in an embodiment, includes a light-emitting diode or an incandescent lamp.

Lighting units 148 are distributed about branches 116 of artificial tree 102. Generally, lighting units 148 are not electrically coupled to one another with traditional wire conductors, but rather, are independent lighting units that operate independently, and may be distributed about branches 116 in any pattern.

In general operation, external power supply 128 provides power to electromagnetic power-supply unit 124. Power-supply unit 124 generates a wireless or radiant electromagnetic energy from antenna 138. The electromagnetic energy emitted from power-supply unit 124 may be any of known frequencies, amplitude, and other characteristics, including radio-frequency. The generation of electromagnetic energy for the purposes of wirelessly power remote devices is generally known in the art. For example, wireless powering of RFID devices are known. An example of an RF power-harvesting system is described and depicted in U.S. Pat. No. 6,615,074, entitled Apparatus for Energizing a Remote Station and Related Method, which is incorporated herein by reference in its entirety. Other systems and methods of wirelessly powering components are described in U.S. Pat. No. 8,432,062, entitled RF Powered Specialty Lighting, Motion, Sound, issued Apr. 30, 2013, which is also incorporated herein by reference in its entirety.

Lighting unit 126 is configured to receive the emitted electromagnetic energy from power-unit 124 at antenna 144. Power is converted by IC 146 and delivered to lighting unit 148, which in an embodiment is an LED, which then emits its own electromagnetic energy in the form of visible light.

In an embodiment, control of wireless light-power system 104 may be accomplished using remote control device 105. In an embodiment, remote control device 105 comprises a smart phone that communicates wirelessly with electromagnetic power-supply unit 124. In other embodiments, remote control device 105 may comprise an infrared or RF-based wireless remote control device.

Referring specifically to FIG. 1, in an embodiment, electromagnetic power-supply unit 124 may define a ring shape configured to be placed on the ground below branches 116 of tree 102. In such an embodiment, antenna 138 forms at least a portion of the ring shape, such that electromagnetic energy is emitted from substantially all points about the ring formed by power-supply unit 124. As will be understood by those of ordinary skill in the art, electromagnetic energy is transmitted upwardly and away from the ring and into the vicinity of branches 116 and lighting units 126. Lighting units 126 receive the energy, and emit light.

In an embodiment, power-supply unit 124 when forming a ring shape, may comprise a generally rigid structure, such as a ring formed by a plastic ring-shaped housing containing one or more power antennas 138. In other embodiments, power-supply unit 124 and specifically antenna 138 may be flexible, such that a user may adjust the shape of the antenna, thereby affecting the direction and distribution of electromagnetic energy. The ability to define the shape, and inner area enclosed by, antenna 138 may be useful to meet the needs of trees of various circumferences, shapes, sizes and other features. Flexibility also allows a user to adjust the direction and distribution of energy to overcome sources of interference that may be obstructing energy distribution, such that some lighting units 126 are not receiving appropriate or sufficient energy.

In an embodiment, the ring shape formed by electromagnetic power-supply 124 may form a circumference that is somewhat greater than the largest circumference of artificial tree 102. In such an embodiment, electromagnetic energy may be best directed to lighting units 126 on branches 116 because the electromagnetic waves to a certain extent are directed inwardly from tips of branches 116 toward trunk portions 114 and 120.

In another embodiment, the ring shape may be somewhat smaller than the largest circumference of tree 102. In such an embodiment, electromagnetic energy is directed generally upwardly through branches 116 to lighting units 126.

In an embodiment power-supply 124 may be placed off the ground and in the interior of the cone formed by branches 116 so that energy emitted is more likely to reach lighting units 126 located at an upper portion of tree 102.

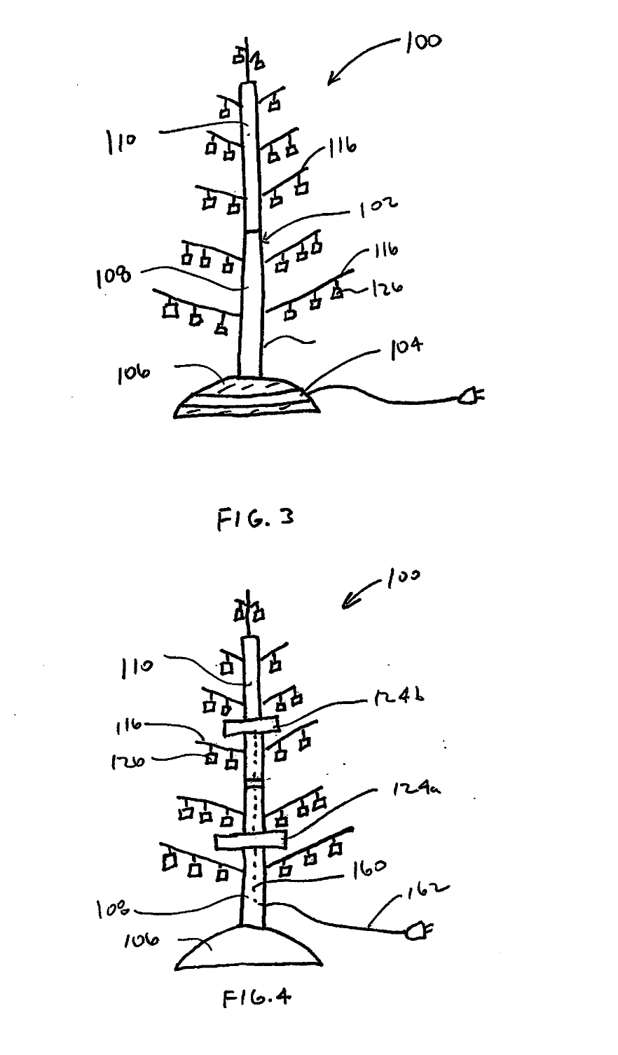

Referring to FIG. 3, an alternate wireless light-power system 104 is depicted. In the depicted embodiment, electromagnetic power-supply unit 124 and/or antenna 138, is integrated into base 106. Such an embodiment may be more convenient to a user due to ease of assembly. In an embodiment, portions of unit 124 are distributed about an exterior of housing 116. In an embodiment, power-supply unit 124 is housed substantially within housing 116.

Referring to FIG. 4, an alternate embodiment of lighted tree system 100 is depicted. In the embodiment depicted, electromagnetic power-supply unit 124 comprises first portion 124a coupled to first tree section 108 and second portion 124b coupled to second tree portion 110.

In an embodiment, internal power wiring 160 may transmit power from power cord 162 to first portion 124a coupled to first tree section 108, as well as transmitting power to second tree section 110. In one such embodiment, tree section 108 may be electrically coupled to tree section 110 by means of an electrical connector or connection system, such as the one described in U.S. Pat. No. 8,454,186, entitled Modular Lighted Tree with Trunk Electrical Connectors, which is incorporated by reference in its entirety herein.

By splitting power-supply unit 124 such that each tree section has a power-emitting portion, the distribution of energy to lighting units 126 is more uniform, ensuring that all lighting units 126 receive the necessary energy to emit light.

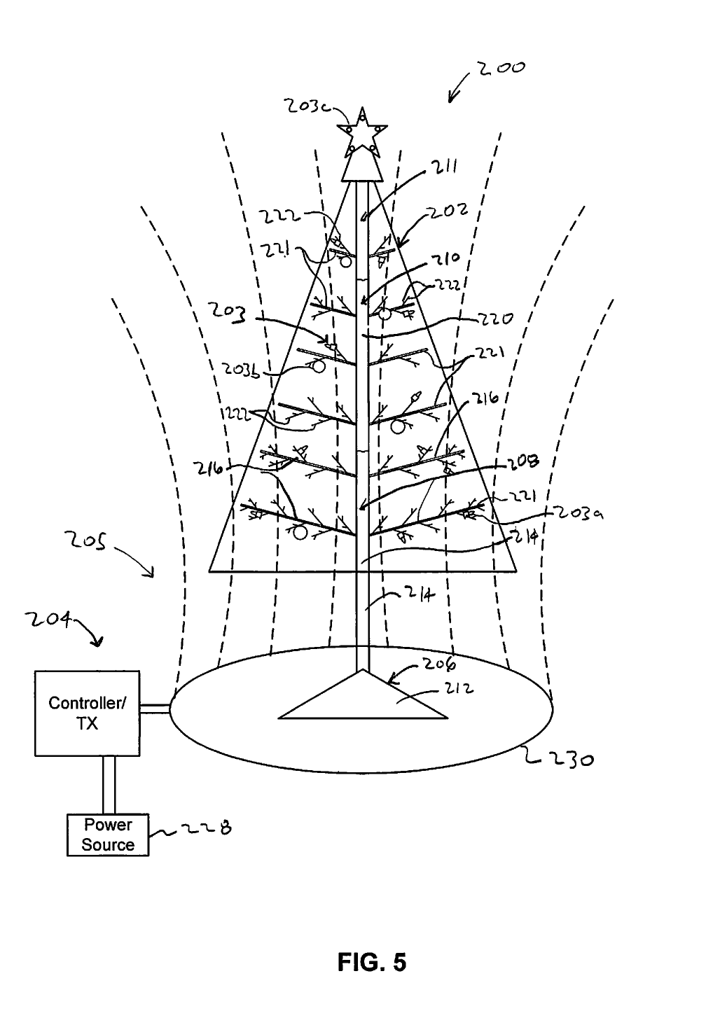

Referring to FIGS. 5-8d, embodiments of a wirelessly-powered lighted artificial tree, wirelessly-powered tree lighting system, transmission and receiver systems configured for operation in the microwave band region are depicted.

While some near-field systems and methods of wirelessly powering seasonal or decorative lighting components using electromagnetic (EM) waves are known, such systems are generally designed to operate at radio frequencies in the 30 KHz to 300 MHz frequency range.

Further, known far-field techniques using microwave power transmission technologies using EM waves in the microwave frequency range of 300 MHz to 300 GHz typically may be used in large-scale power transfer systems transferring high-power signals over long distances. Because of the “line of sight” properties of microwaves, point-to-point transmission of microwave signals through air or space and over significant distances are known. Contrary to such use of microwave power transmission techniques, embodiments herein use microwave power transmission to power lighting devices in relatively close proximity to its microwave transmission source, and may also include wireless transmission of data embedded in the microwave power signal. Such embodiments herein, include devices, systems and methods of wirelessly powering seasonal lighting using microwave-frequency wireless signals.

Wireless power transfer at microwave frequencies, including at “radar” frequencies, e.g., in the established C Band, X Band, K Band, and so on, offer some advantages with respect to wireless power transfer, but the short wavelength and easily reflected properties of microwaves can present challenges when applied to decorative lighting, and in particular lighting of artificial trees, which may include lighting elements distributed about a tree, and which generally include trunks, branches and materials that may interfere with signal transmission. Embodiments herein provide effective and efficient solutions for wireless powering of lighting and lighted trees as described below, and in some instances, wireless data transmission for controlling such wireless lighting.

Referring specifically to FIG. 5, an embodiment of a wireless microwave-power and data transfer tree system 200 is depicted. System 200 includes artificial tree 202, wireless tree-lighting system 203, and wireless microwave power and data transmission system 204. Generally speaking, wireless tree-lighting system 203 functions as a receiver, while wireless microwave power and data transmission system 204 functions as a transmitter, together comprising wirelessly-powered lighting system 205 for tree 202.

In an embodiment, artificial tree 202 may be substantially the same as artificial tree 102, and in an embodiment, includes base 206, one or more tree sections, including first tree section 208, second tree section 210, and optional third tree section 211.

Base 208 is configured to support first tree section 208, and may be configured to receive a portion of a trunk of tree section 208 in a vertical position. Base 206 may comprise any of a variety of structural configurations, including the one depicted. In an embodiment, base 206 comprises a housing 212 that defines an inner cavity for housing various components of wireless light-power system 206, power-supply components, wiring, wireless or wired communication components, and so on. Base 206 may comprise multiple “legs” extending outwardly from a center portion of base 206 to support artificial tree 102.

First tree section 208 includes trunk portion 214 and a plurality of branches 216. Branches 216 are coupled to trunk portion 214 and extend outwardly and away from trunk portion 214. In an embodiment, trunk portion 214 may comprise a metal material, and may generally be hollow, defining an interior cavity. In other embodiments, trunk portions 214 (and 220) may comprise other materials less likely to reflect microwaves, such as a polymer or other material.

In an embodiment, branches 216 are arranged in groups at discrete “heights” along trunk portion 214, in a manner similar to that described above with respect to tree 100. In an embodiment, each branch 216 may comprise primary shaft 221, secondary shafts 222, and branch portions or projections 224 resembling artificial pine “needles”. Primary shafts 220 and secondary shafts 222 may comprise a conventional metal material for rigidity. However, in alternate embodiments, shafts 221 and 222 may comprise other materials having conduction and dielectric properties resulting in improved transmission of microwave frequency signals through tree 202. Such materials may include a polymer, such as polyvinyl chloride (PVC) having a permittivity ∈ᵣ of 2.91 and a conductivity 0.00400 S/m. In one such embodiment employing PVC branch portions 224, portions 224 may comprise thin, flexible strips or ribbons of PVC wrapped about, and projecting from shafts 221 and/or 222. Because microwave signals generally penetrate or transmit through PVC material fairly efficiently, the use of relatively thin, strip-like material for artificial needles, and of a material like PVC, improves transmission of microwave-frequency wireless signals throughout tree 202.

Other polymers, such as polyethylene having a permittivity ∈ᵣ of 2.51 and a lower conductivity 0.00004 S/m, may also be used.

Second tree section 210 is substantially the same as tree section 208, and includes trunk portion 120 and branches 116. In an embodiment, groups of branches 116 may be coupled to trunk portion 120 at common trunk portion locations or heights, in a fashion similar to that described above.

Third tree section 211 may be substantially the same as first and second tree sections 208 and 210, or in an alternate embodiment, may comprise a narrower trunk section and generally be smaller as depicted, and as compared to sections 208 and 210.

First tree section 208 is configured to mechanically couple to second tree section 210 at their respective trunk portions, along a common vertical axis. In an embodiment, in addition to a mechanical coupling of tree section 208 and 210, the tree sections may also electrically couple via power transmission connectors, as described above with respect to lighted tree system 100. In such a configuration, wireless microwave power and data transmission system 204 may be a distributed system, similar to that depicted in FIG. 4 above.

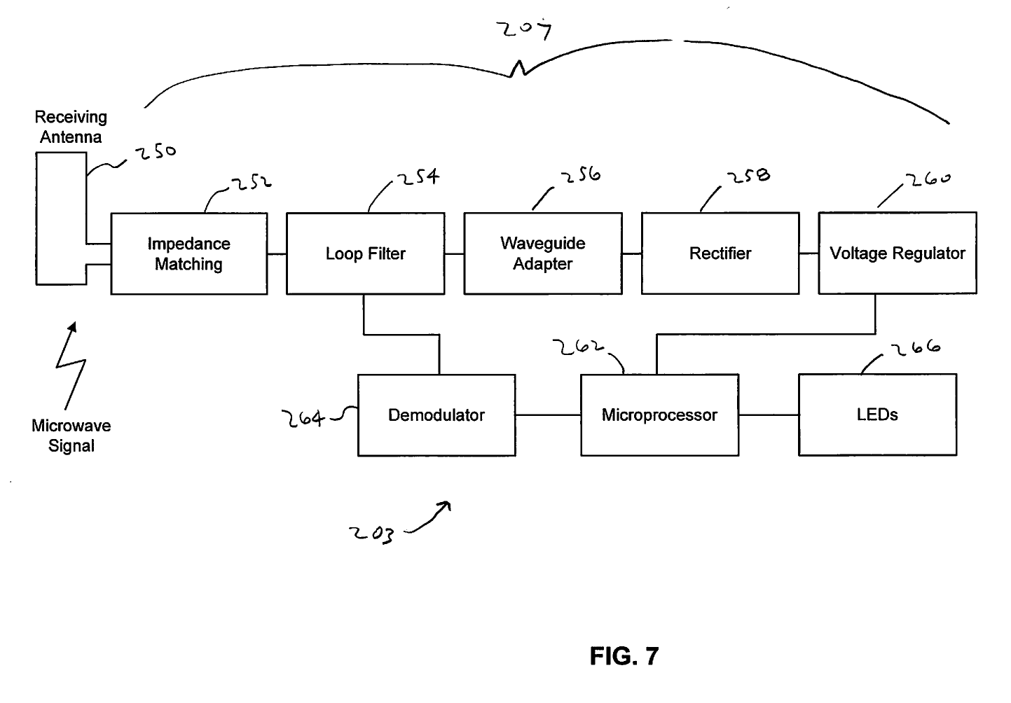

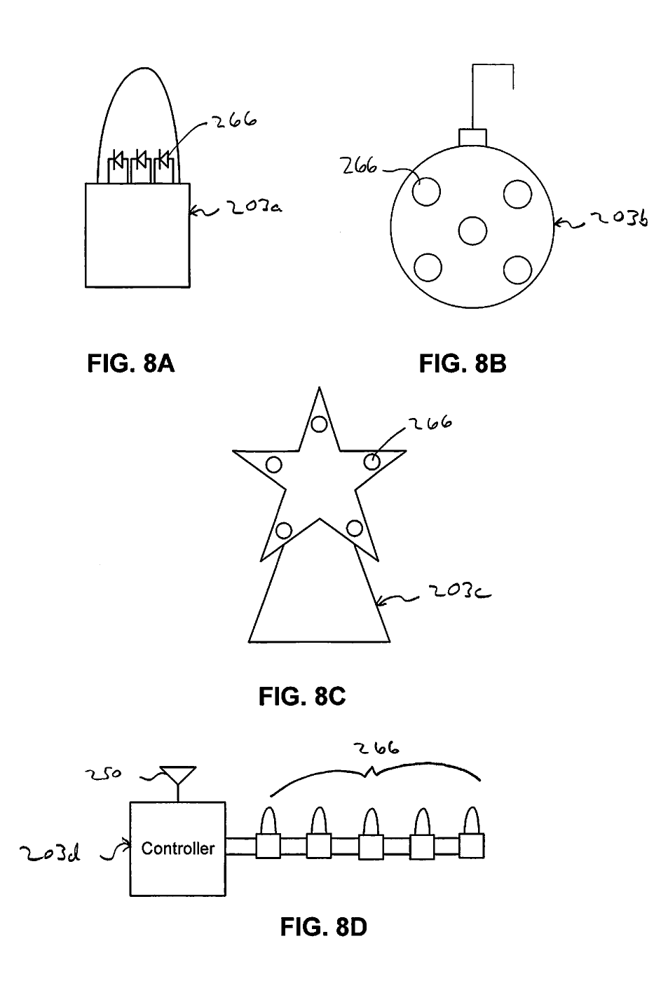

Still referring to FIG. 5, wireless tree lighting system 203 may include a variety of forms of lighting elements and systems distributed about branches 116 of tree 202, and may include individual lighting elements and/or lighting strings, lighting ornaments, and other such lights distributed about branches 116, configured to receive wireless microwave frequency transmissions from wireless microwave power and data transmission system 204. Embodiments of other “wireless” tree lighting systems 203 will be described further below with respect to FIGS. 7 and 8a-8d.

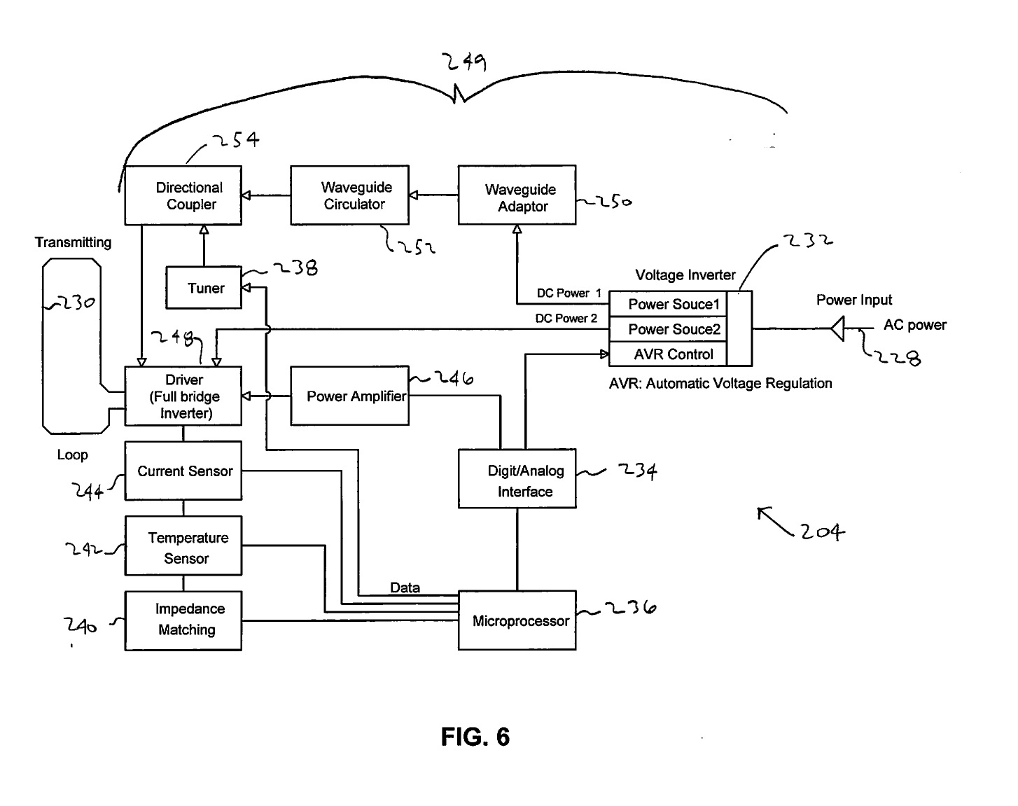

Referring also to FIG. 6, an embodiment of wireless microwave power and data transmission system 204 is depicted. Wireless microwave power and data transmission system 204 is configured to receive power from external power source 228, which in an embodiment, may be an alternating-current (AC) power source. In an embodiment, wireless microwave power and data transmission system 204 includes transmission antenna 230 and a plurality of power and data transmission components as described further below.

In an embodiment, wireless microwave power and data transmission system 204 includes transmitting antenna 230, power-conditioning subsystem 232, digital/analog (D/A) interface 234, processor 236, tuner 238, impedance matching subsystem and components 240, temperature sensor 242, current sensor 244, driver 248, waveguide adapter 250, waveguide circulator 252 and directional coupler 254.

In an embodiment, transmitting antenna 230 may comprise a loop antenna as depicted. Transmitting antenna or transmission antenna 230 may comprise other antenna shapes and forms as will be understood by those skilled in the art of antenna design. In an embodiment, antenna 230 may comprise a “loop” or generally circular shape, and may surround or encompass tree 202 as depicted.

Power-conditioning subsystem 232 is configured to receive an input power, such as an AC input power, from external power source 228. In an embodiment, power-conditioning subsystem 232 may comprise a voltage inverter, and include circuitry and electrical components comprising a first power source (“power source 1”) generating a first DC power (“DC Power 1”) which is transmitted to waveguide adapter 250. Power-conditioning subsystem 232 may also include circuitry and electrical components comprising a second power source (“power source 2”) generating and providing a second DC power signal for driver 248. Power-conditioning subsystem 232 may also include an automatic voltage regulation (AVR) circuit controlled by, or in communication with, microprocessor 236 through D/A interface 234 for automatically regulating one or more voltages of power-conditioning subsystem 232.

Processor 236, may comprise any of a number of known processors, microprocessors, controllers and so on, and may include volatile and non-volatile memory storing data and algorithms. In an embodiment, and as depicted, processor 236 is in electrical communication with D/A interface 234, tuner 238, impedance matching subsystem 240, and temperature sensor 242.

In an embodiment, processor 236 may also be in wireless communication with a remote controller (not depicted), such as an RF remote control device, smartphone or other such hand-held device, receiving control commands from a user of the remote control device.

Processor 236 is in electrical communication with tuner 238.

As will be understood by those of ordinary skill, system 204 may also include impedance matching subsystem and components 240 to match load and source impedances, as will be understood by those of ordinary skill.

In an embodiment, wireless microwave power and data transmission system 204 may also include temperature sensor 242 in electrical communication with processor 236. Temperature sensor 242 may monitor and communicate an ambient temperature at system 204, and may also be configured to monitor temperatures of various components of system 204, such as power amplifier 246, waveguide adapter 250, waveguide circulator 252 and/or other components. As will be understood by those of ordinary skill, thermal stress may affect operation and performance of system components, such as amplifier gain and waveguide transmission. When generating microwave-frequency signals and transmitting using waveguides, monitoring temperature and making appropriate control adjustments ensures accurate and efficient operation.

In an embodiment, wireless microwave power and data transmission system 204 may also include current sensor 244 in electrical communication with processor 236. Current sensor 244 may be configured to monitor an overall system current, and/or electrical current associated with antenna 230.

Wireless microwave power and data transmission system 204, in an embodiment, includes power amplifier 246 in electrical communication with processor 236 through D/A interface 234.

Wireless microwave power and data transmission system 204, in an embodiment, includes driver 248, which in an embodiment, comprises a full-bridge inverter. Driver 248 is in electrical communication with power amplifier 246 and directional coupler 254. As will be described further below, driver 248 delivers a power signal, and in some instances, a data signal, to antenna 230 for wireless lighting system 203 of tree 202.

As one of ordinary skill will understand, transmission of microwave frequency signals is most efficiently accomplished using waveguide technology. Consequently, wireless microwave power and data transmission system 204 includes, in an embodiment, waveguide adapter 250 which is connected to, or in communication, with power subsystem 232 and waveguide circulator 252.

Directional coupler 254 is in communication with waveguide circulator 252 and tuner 238.

In general operation, wireless microwave power and data transmission system 204 transmits a microwave-frequency transmission signal that at least provides power to tree lighting system 203, and in some cases, provides a data or control signal embedded in the power signal, i.e., provides a modulated microwave-frequency power signal.

More specifically, external power source 228 provides an AC power to power-conditioning subsystem 232. Power-conditioning subsystem 232 converts incoming AC power to outgoing DC power, as will be understood by those of ordinary skill in the art. A first DC power source (“Power Source 1”) generates a first power (“DC Power 1”), which is delivered to waveguide adapter 250. A second DC power source (“Power Source 2”) generates a second power (“DC Power 2”), which is delivered to driver 248.

In an embodiment, voltage regulation is accomplished using AVR, automatic voltage regulation, so as to ensure that accurate and constant DC power is output by system 232. In an embodiment, AVR takes in a range of voltage levels from external source 228, and outputs a narrower range of voltage levels. In some embodiments, AVR may increase or decrease incoming AC voltage as part of the power conditioning and in some embodiments, rectifying process to deliver an appropriate DC output power.

DC Power 1 is transmitted to waveguide adapter 250, through waveguide circulator 252 and to directional coupler 254. In an embodiment, processor 236 controls tuner 238 to produce a constant DC power signal output from directional coupler 254. In another embodiment, processor 236 provides a data/control signal to tuner 238, which delivers a data signal to directional coupler 254 via tuner 238, resulting in directional coupler outputting a modulated signal that includes the data provided by processor 236.

Driver 248, which in an embodiment comprises a full-bridge inverter, converts the signal received from directional coupler 254 to a modulated AC signal in a microwave frequency range which is in turn transmitted into antenna 230.

Consequently, Power Source 1, waveguide adapter 250, waveguide circulator 252, directional coupler 254, tuner 238 and driver 248 comprise an embodiment of a microwave-frequency signal generation portion 249 of system 204.

Antenna 230 receives the modulated AC signal in the microwave frequency range and then wirelessly transmits a modulated AC signal in the microwave-frequency range based on the received modulated AC signal, to receivers of lighting system 203. The transmitted signal may be substantially the same as, or similar to, the received modulated AC signal in the microwave frequency range. Those of ordinary skill in the art will understand that some losses and distortion of the received signal may result in the transmitted signal being somewhat different than the received signal.

The microwave frequency of the generated signal may vary. Most generally, system 204 may generate wireless signals within the range of 300 MHz to 300 GHz. In some embodiments, signals are generated in the 7-10 GHz range. In other embodiments, signals are generated and/or transmitted in the upper radar frequency range, including in the C, X, and K bands. In other embodiments, signals are generated and/or transmitted at approximately 2.45 GHz, 5.8 GHz, 8.5 GHz, 10 GHz or 35 GHz.

During the wireless microwave power and data signal generation process, processor 236 may communicate with temperature sensor 242 and current sensor 244 to monitor temperature and current conditions of system 204.

Referring now to FIG. 7, an embodiment of lighting system 203 is depicted. Wireless-powered lighting system 203 includes impedance matching circuitry 252, loop filter 254, waveguide adapter 256, rectifier 258, voltage regulator 260, processor 262, demodulator 264, and lighting elements (“LEDs”) 266.

In operation, the microwave-frequency signal transmitted from wireless microwave power and data transmission system 204 is received at receiving antenna 250. In an embodiment, receiving antenna 250 may comprise a loop antenna as depicted, though in other embodiments, antenna 250 may comprise other types of antennas configured to receive a wireless signal in the microwave frequency range.

The received microwave signal is transmitted through impedance matching circuitry and components 252, as will be understood by those of ordinary skill, and received at loop filter 252.

Loop filter 252 filters or separates the incoming microwave-frequency signal, and directs a version of the signal to waveguide adapter 256, which conditions the signal to be received by rectifier 258. Rectifier 258 converts the incoming AC microwave signal into a DC power signal, which is received by voltage regulator 260.

Voltage regulator 260 regulates the power signal received by rectifier 258 to a steady voltage usable by processor 262. Consequently, the incoming high-frequency, modulated AC microwave signal has been converted to a low-voltage DC signal for use by processor 262 (and LEDs 266).

Loop filter 252 also directs a filtered version of the received signal to demodulator 264. Demodulator 264 demodulates the incoming signal to extract or determine the data portion of the received microwave signal, and transmits that data to processor 262.

In an embodiment, loop filter 254, waveguide adapter 256, rectifier 258, voltage regulator 260 and optionally, impedance matching circuit 252, comprise wireless-microwave-signal power conversion portion 207.

Processor 262 is thusly powered by the received microwave-frequency signal, and receives data, which may be data relating to control of the lighting elements or LEDs 266. Processor 266 then selectively powers LEDs 266 based on the received control data.

As depicted, processor 262 directly powers LEDs 266. However, it will be understood that processor 262 may simply control power to LEDs 266 through other electrical components, e.g., electronic switches or other processors or similar such devices configured to selectively control power.

In this embodiment, the lighting elements 266 depicted as receiving the power are light-emitting diodes (LEDs), though other forms of lighting elements may be used.

Referring to FIGS. 8a-8d, wireless lighting system 203 may take a variety of forms, all generally including the components described in FIG. 7 above. In an embodiment, wireless lighting system 203 may comprise wireless lighting assembly 203a, which comprises several LEDs in a common housing. The several LEDs may comprise an RGB diode arrangement controlled by an IC chip comprising a processor. The red, green and blue diode chips are selectively controlled to generate one of many possible light colors. In an embodiment, the IC chip may comprise processor 262, and the depicted LEDs may comprise LEDs 266 of FIG. 7.

In another embodiment, wireless lighting system 203 comprises a wireless lighted ornament 203b having multiple LEDs 266. Processor 262 may control LEDs 266 separately, together or in other various sequences as desired. System 203b may include additional processors in communication with a primary processor 262. In the depicted embodiment, system 203b is configured to be hung on a branch 116 of tree 202.

In another embodiment, wireless lighting system 203 may comprise a lighted “tree-top” device 203c, which is substantially similar to ornament system 203b, described above, except adapted to be fitted to a top portion of tree 202, such as at tree section 211.

In yet another embodiment, wireless lighting system 203 may comprise wirelessly-powered light string 203d. In an embodiment, electrical components of wireless lighting system 203, with the exception of LEDs 266, may be grouped together, and connected to a string of LEDs 266 that may be wired together in parallel. In this case, processor 262 may be wired to a first LED 266, then electrically connected through parallel wiring of a number of other LEDs 266 as depicted. Strictly speaking, light string 203d is not “wireless” since there may be wires interconnecting the LEDs, however, it will be understood that power is received wirelessly.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed:

1. A wirelessly-powered lighted tree system, comprising:
an artificial tree, including a trunk and a plurality of branches;
a wireless power and data transmission system, including:
a power conditioning portion configured to receive an alternating-current (AC) power from an external source, and convert the AC power to a direct-current (DC) power;
a microwave-frequency signal generation portion configured to receive the DC power from the power conditioning circuit and generate a microwave-frequency signal;
a processor in electrical communication with the power-conditioning portion;
an antenna in electrical communication with the microwave-frequency signal generation portion and configured to receive the generated microwave-frequency signal and to transmit a wireless microwave-frequency signal based on the received microwave-frequency signal from the microwave-frequency generation portion; and
a wirelessly-powered lighting system configured to receive the transmitted wireless microwave-frequency signal, the lighting system including an antenna receiving the transmitted wireless microwave-frequency signal, a power conversion portion for converting the wireless microwave-frequency signal into a DC power signal, and a plurality of lighting elements coupled to the artificial tree and receiving power based on the DC power signal.

2. The wirelessly-powered lighted tree system of claim 1, wherein the transmitted wireless microwave-frequency signal is a wireless signal having a frequency in the range of 7 GHz to 10 GHz.

3. The wirelessly-powered lighted tree system of claim 1, wherein the wireless power and data transmission system further comprises a modulation portion, and wherein the transmitted wireless microwave-frequency is a modulated wireless signal that includes a data signal portion.

4. A method of wirelessly powering an artificial tree having a plurality of lighting elements distributed about branches of the tree, comprising:
causing a wireless power and data transmission system to transmit a wireless microwave-frequency signal;
receiving a wireless signal based on the wireless microwave frequency signal at a wirelessly-powered lighting system, the lighting system attached to a branch of an artificial tree;
converting the received wireless signal to a DC power signal and powering a lighting element of the lighting system using the DC power signal.
